(19) United States
(12) Patent Application Publication
(10) Pub. No.: US 2013/0016197 A1
(43) Pub. Date: Jan. 17, 2013

(54) URINAL WHERE IMAGING DEVICE IS INSTALLED

(71) Applicant: Young Man Koo, Gwangju (KR)

(72) Inventor: Young Man Koo, Gwangju (KR)

(73) Assignee: HEAD TURNER CO., LTD., Gwangju (KR)

(21) Appl. No.: 13/511,056

(22) PCT Filed: Nov. 24, 2010
(86) PCT No.: PCT/KR2010/008358

§ 371 Date: May 21, 2012

(30) Foreign Application Priority Data
Dec. 4, 2009 (KR) 10-2009-0120107

(51) Int. Cl. H04N 7/18

(52) U.S. Cl. 348/61; 348/E07.085

(57) ABSTRACT

Disclosed is a urinal having an imaging device while not supplying washing water thereto. The urinal includes a main body having its front surface opened and a urine drainage hole provided at its lower portion, a recognition portion that senses a human body approaching the main body or a user's manipulation, and an imaging portion that displays a water flowing pattern image or a nature image inside or outside the main body when a human body approach signal or a manipulation signal is received from the recognition portion. According to the urinal having an imaging device, since an imaging portion is provided inside or outside the urinal, to which washing water is not supplied, an optical illusion may be cause to a user being accustomed to using a flushing type urinal so that the user is likely to believe that the urine is washed away even if urine washing water is not actually supplied to the urinal. Alternatively, while urinating, the user's feel of being refreshed can be maximized after urination by offering a carefree urination effect to the user so that the user may feel as if he were urinating in Mother nature.

### TECHNICAL FIELD

The present invention relates to a urinal having an imaging device installed therein, and more particularly, to a urinal having an imaging device configured to display a water flowing pattern image or a nature image inside or outside the urinal.

### BACKGROUND ART

In general, a urinal is fixedly installed on the wall or bottom and is mainly used in public places or toilets used by a number of people.

The urinal includes a urinal main body, a drain valve installed at an upper portion of the urinal main body to flush washing water, and a drainage hole at a lower portion of the urinal main body to drain urine and washing water to the outside. The urinal is configured such that urine is flushed using water discharged by a user pressing the drain valve or by actuating an automatic valve after the user urinates and the discharged water flows along the inner surface of the urinal main body to then wash away the urine. Here, the washing water and urine are discharged through the drainage hole.

However, the conventional urinal has a problem in that a large amount of water is required because urine is washed away using washing water.

Meanwhile, another urinal system may also be employed, to which no washing water is supplied. In this case, a user of the conventional flushing type urinal may feel displeasure due to unavailability of washing water after urinating.

### ADVANTAGEOUS EFFECTS

In the urinal having an imaging device according to the present invention, since an imaging portion is provided inside or outside the urinal, to which washing water is not supplied, an optical illusion may be cause to a user being accustomed to using a flushing type urinal so that the user is likely to believe that the urine is washed away even if urine washing water is not actually supplied to the urinal. Alternatively, while urinating, the user's feel of being refreshed can be maximized after urination by offering a carefree urination effect to the user so that the user may feel as if he were urinating in Mother Nature.

### DISCLOSURE OF THE INVENTION

In order to overcome the above-mentioned shortcomings, the present invention provides a urinal having an imaging device, which can remedy user's displeasure felt when the user used a urinal without washing water, by indicating a water flowing pattern image or a nature image.

According to an aspect of the invention, there is provided a urinal having an imaging device while not supplying washing water thereto, the urinal including a main body having its front surface opened and a urine drainage hole provided at its lower portion, a recognition portion that senses a human body approaching the main body or a user's manipulation, and an imaging portion that displays a water flowing pattern image or a nature image inside or outside the main body when a human body approach signal or a manipulation signal is received from the recognition portion.

The imaging portion may include a plurality of light sources arranged horizontally and vertically in lines inside the main body, and a control unit that controls the light sources to be lit vertically from an upper light source to a lower light source to display a water flowing pattern image, wherein a surface of the main body facing the light sources is formed using a transparent material to display the image of the imaging portion.

The imaging portion may include an image display unit installed inside the main body to display a water flowing pattern image or a nature image.

The main body may further include an acoustic unit outputting sound, and the imaging portion controls the acoustic unit to output sound when the imaging portion receives a human body approach signal from the recognition portion.

The imaging portion may be installed in the main body having a screen installed thereat and may include a beam projector projecting a water flowing pattern image or a nature image on the screen inside or outside the main body.

### BRIEF DESCRIPTION OF THE DRAWINGS

The objects, features and advantages of the present invention will be more apparent from the following detailed description in conjunction with the accompanying drawings, in which:

FIG. 1 is a perspective view of a urinal having an imaging device according to the present invention;

FIG. 2 is a partly cut-away perspective view of the urinal shown in FIG. 1;

FIG. 3 is a circuit view of a control unit of the urinal shown in FIG. 1;

FIG. 4 is a partly cut-away perspective view of an imaging portion having an image display unit in the urinal shown in FIG. 1;

FIG. 5 is a circuit view of a control unit of the urinal shown in FIG. 4;

FIG. 6 is a cross-sectional view illustrating a beam projector of the imaging portion shown in FIG. 1 is installed inside the urinal;

FIG. 7 is a cross-sectional view illustrating a beam projector of the imaging portion shown in FIG. 1 is installed outside the urinal; and

FIG. 8 is a circuit view of a control unit of the urinal shown in FIGS. 6 and 7.

### BEST MODE FOR CARRYING OUT THE INVENTION

Hereinafter, a urinal having an imaging device according to the present invention will be described in more detail with reference to the accompanying drawings.

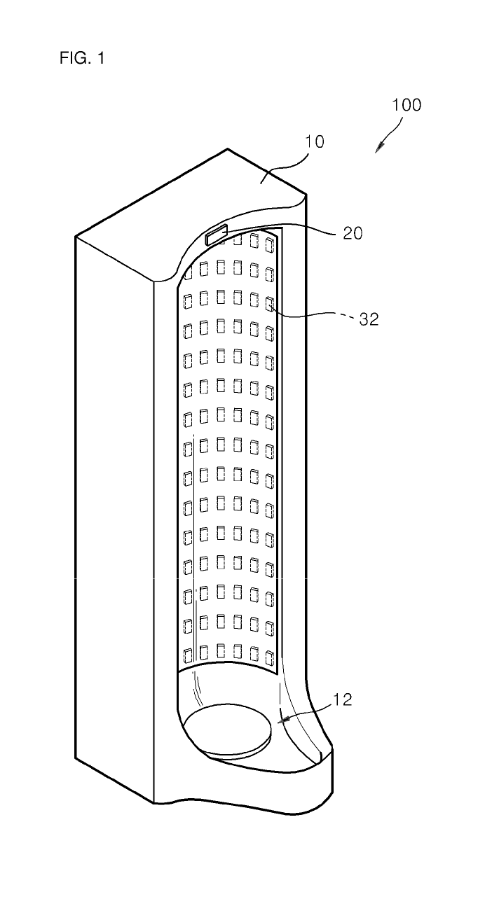

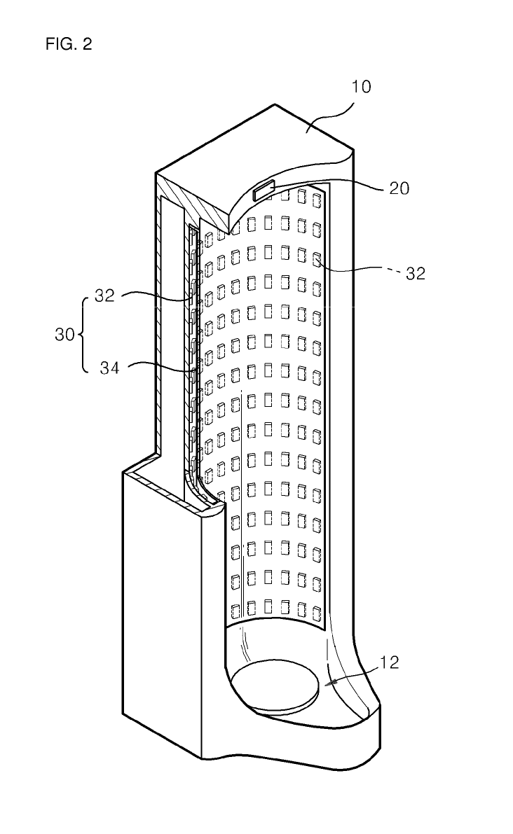

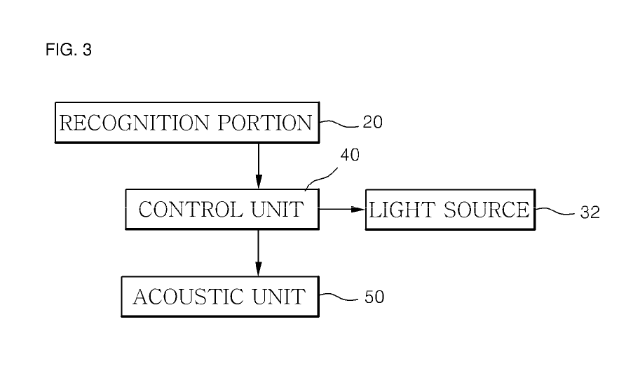

FIG. 1 is a perspective view of a urinal having an imaging device according to the present invention, FIG. 2 is a partly cut-away perspective view of the urinal shown in FIG. 1, and FIG. 3 is a circuit view of a control unit of the urinal shown in FIG. 1.

Referring to FIGS. 1 to 3, the urinal 100 having an imaging device according to the present invention includes a main body 10, a recognition portion 20 and an imaging portion 30.

The main body 10 is configured to have a general shape such that its front surface is opened and a urine drainage hole 12 is provided at its lower portion. The main body 10 is formed using a material having functions of suppressing bacteria breeding and deodorizing.

Preferably, the main body 10 is fabricated to have a function of permanently emitting far-infrared rays or negative ions by mixing some of a new material prepared by mixing silicon oxide, feldspar oxide, boric acid, cobalt, acetic acid, magnesium, etc. based on the total weight of the main body 10 and sintering the mixture at approximately 1500° C., and molding the new material mixture.

The recognition portion 20 may include light receiving/emitting sensor installed at an upper portion of the main body 10 to sense a human body approach. Alternatively, the recognition portion 20 may be shaped of a button provided to a general cleaning function, so that the user may press the button when the user wants to operate the imaging portion 30 to be described later.

Unlike in the illustrated embodiment, the recognition portion 20 may also be installed at a location where a human body approach can be sensed, in addition to the upper portion of the where main body 10.

The imaging portion 30 includes light sources 32, a control unit 40 and a cover 34. The light sources 32 are installed on an opened inner surface of the main body 10. The light sources 32 are horizontally and vertically arranged to output a water flowing pattern image.

When a human body approach signal or a button manipulation signal is received from the recognition portion 20, the control unit 40 controls the light sources 32 to be lit sequentially from upper light sources 32 to lower light sources 32. Accordingly, the water flowing pattern image can be displayed. The cover 34 is made of a transparent material and is installed on the inner surface of the opened main body 10 to face the light sources 32. Here, the cover 34 is engaged with the main body 10 to shut down induction of urine. Unlike in the illustrated embodiment, after the light sources 32 are installed on the opened inner surface of the main body 10 and the inner surface is transparently coated. Alternatively, a surface of the main body 10 facing the light sources 32 installed in the main body 10 may be formed using a transparent material. Here, the coating material used herein may be a transparent material having a waterproof effect.

Preferably, the main body 10 further includes an acoustic unit 50. The acoustic unit 50 outputs sound when the human body approach signal is received from the recognition portion 20. Here, the sound output from the acoustic unit 50 may include the patter of raindrops or nature sound output adaptively to the image output from the imaging portion 30.

The operation of the aforementioned urinal 100 will now be described in detail. When a user approaches the main body 10 of the urinal 100, the human body approach signal is output to the control unit 40 by the recognition portion 20. If the human body approach signal is received in the control unit 40, the light sources 32 of the imaging portion 30 are lit by the control unit 40. The light sources 32 are sequentially lit from upper light sources 32 to lower light sources 32 to display a water flowing pattern image. When the light sources 32 are lit, the sound is output from acoustic unit 50 by the control unit 40.

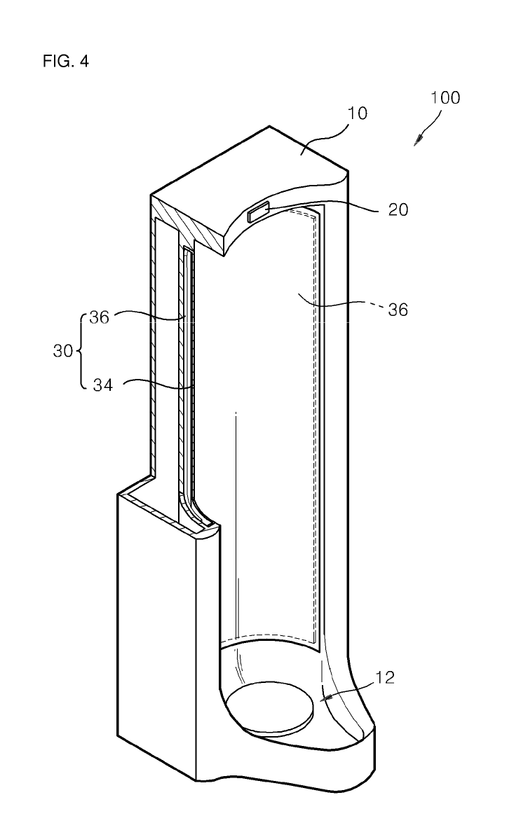

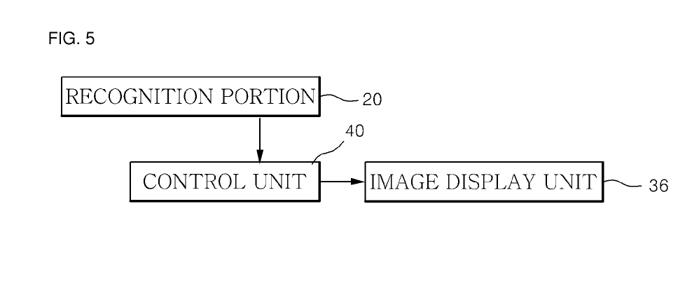

In the above-described embodiment, the imaging portion 30 includes a plurality of light sources 32. Unlike in the previous embodiment, in another embodiment, the imaging portion 30 may include an image display unit 36, which are shown in FIGS. 4 and 5.

FIG. 4 is a partly cut-away perspective view of an imaging portion having an image display unit in the urinal shown in FIG. 1 and FIG. 5 is a circuit view of a control unit of the urinal shown in FIG. 4.

The imaging portion 30 includes an image display unit 36 installed on an opened inner surface of the main body 10. A cover 34 is formed using a transparent material and is installed on the opened inner surface of the main body 10 to face the image display unit 36. When a human body approach signal or a button manipulation signal is received from the recognition portion 20, the control unit 40 controls the image display unit 36 to output a water flowing pattern image or a nature image, which is pre-stored in the image display unit 36. Examples of the nature image may include images of a lawn, a field of reeds, a wild plain, a mountain valley, and so on. Here, a display unit including may be used as the image display unit 36 a liquid crystal display (LCD), an organic electroluminescent (EL) device, an inorganic EL device, a light emitting diode (LED), an active matrix organic light emitting diode (AMOLED), and so on.

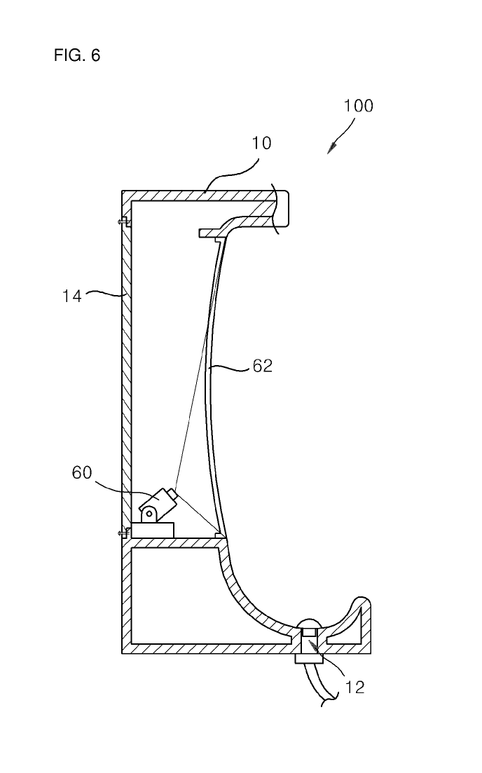

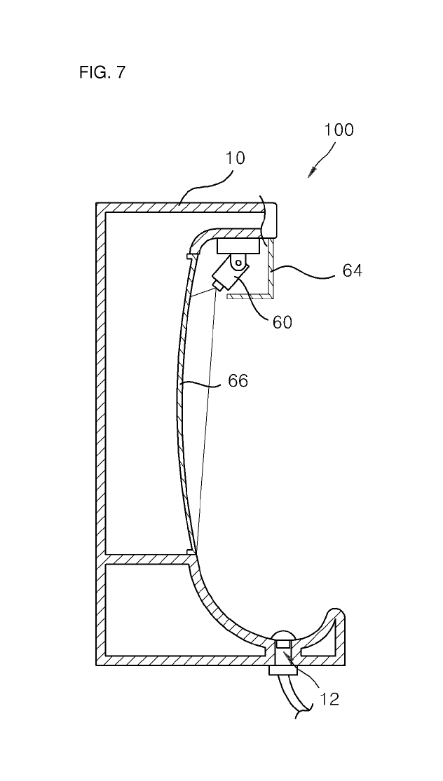

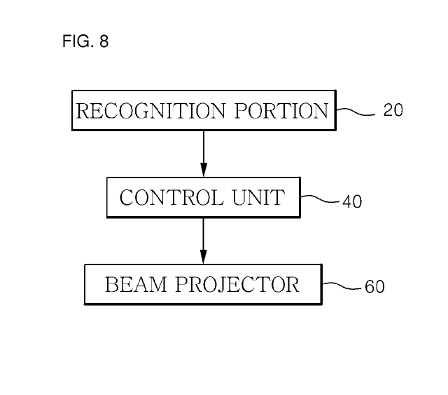

A still another embodiment of the present invention is illustrated in FIGS. 6 to 8. FIG. 6 is a cross-sectional view illustrating a beam projector of the imaging portion shown in FIG. 1 is installed inside the urinal, FIG. 7 is a cross-sectional view illustrating a beam projector of the imaging portion shown in FIG. 1 is installed outside the urinal, and FIG. 8 is a circuit view of a control unit of the urinal shown in FIGS. 6 and 7.

A beam projector 60 installed inside a main body 10 is used as the imaging portion. The main body 10 has a main body cover 14 having an opened rear surface to install the beam projector 60. The main body cover 14 is coupled to the main body 10 by thread engagement. When installing the beam projector 60, the main body cover 14 is separated from the main body 10. After installing the beam projector 60, the main body cover 14 is coupled to the main body 10. The control unit 40 controls the beam projector 60 installed inside the main body 10 to project a water flowing pattern image or a nature image on a transparent screen 62 when a human body approach signal or a button manipulation signal is received from the recognition portion 20.

A further embodiment of the present invention is illustrated in FIGS. 7 and 8. FIG. 7 is a cross-sectional view illustrating a beam projector of the imaging portion shown in FIG. 1 is installed outside the urinal, and FIG. 8 is a circuit view of a control unit of the urinal shown in FIGS. 6 and 7.

A beam projector 60 installed outside the main body 10 is used as the imaging portion. The main body 10 has a protection cover 64 formed at a location of the beam projector 60 to prevent urine from being induced into the beam projector 60.

The control unit 40 controls the beam projector 60 installed inside the main body 10 to project a water flowing pattern image or a nature image on an opaque screen 66 when a human body approach signal or a button manipulation signal is received from the recognition portion 20.

Although exemplary embodiments of the present invention have been described in detail hereinabove, it should be understood that many variations and modifications of the basic inventive concept herein described, which may appear to those skilled in the art, will still fall within the spirit and scope of the exemplary embodiments of the present invention as defined by the appended claims.

What is claimed is:

1. A urinal having an imaging device while not supplying washing water thereto, the urinal comprising:
a main body having its front surface opened and a urine drainage hole provided at its lower portion;
a recognition portion that senses a human body approaching the main body or a user's manipulation; and
an imaging portion that displays a water flowing pattern image or a nature image inside or outside the main body when a human body approach signal or a manipulation signal is received from the recognition portion.

2. The urinal of claim 1, wherein the imaging portion includes a plurality of light sources lined and arranged horizontally and vertically inside the main body, and a control unit that controls the light sources to be lit vertically from an upper light source to a lower light source to display a water flowing pattern image, wherein a surface of the main body facing the light sources is formed using a transparent material to display the image of the imaging portion.

3. The urinal of claim 1, wherein the imaging portion includes an image display unit installed inside the main body to display a water flowing pattern image or a nature image.

4. The urinal of claim 1, wherein the main body further includes an acoustic unit outputting sound and the imaging part controls the acoustic unit to output sound when the imaging portion receives a human body approach signal from the recognition portion.

5. The urinal of claim 1, wherein the imaging portion is installed in the main body having a screen installed thereat and includes a beam projector projecting a water flowing pattern image or a nature image on the screen inside or outside the main body.
